(19) United States
(12) Patent Application Publication
(10) Pub. No.: US 2025/0362657 A1
(43) Pub. Date: Nov. 27, 2025

(54) GATEWAY DEVICE, RELAY METHOD, AND COMPUTER READABLE MEDIUM

(71) Applicant: Mitsubishi Electric Corporation, Tokyo (JP)

(72) Inventors: Suguru HIRATA, Tokyo (JP); Kiyohito MIYAZAKI, Tokyo (JP)

(73) Assignee: Mitsubishi Electric Corporation, Tokyo (JP)

(21) Appl. No.: 19/295,858

(22) Filed: Aug. 11, 2025

Related U.S. Application Data
(63) Continuation of application No. PCT/JP2023/013770, filed on Apr. 3, 2023.

(51) Int. Cl. G05B 19/042

(52) U.S. Cl. CPC G05B 19/0423

(57) ABSTRACT

A gateway device (10) relays communication between an input and output device (20) and a control device (30). When the gateway device (10) receives a non-safety output being an output signal to control the control state of the input and output device (20) to a non-safe state from the control device (30), it decides whether a safety input being an input signal to control the control state to a safe state during a storage period before reception has been received from the input and output device (20). If it is decided that the safety input has been received, the gateway device (10) does not relay the non-safety output to the input and output device (20), but transmits a safety output being an output signal to control the control state of the input and output device (20) to the safe state, to the input and output device (20).

### CROSS REFERENCE TO RELATED APPLICATION

This application is a Continuation of PCT International Application No. PCT/JP2023/013770, filed on Apr. 3, 2023, which is hereby expressly incorporated by reference into the present application.

### TECHNICAL FIELD

The present disclosure relates to a gateway device that relays communication between an input device and an output device, and a control device that controls the output device based on input signals from the input device.

### BACKGROUND ART

With the recent development of cloud computing, systems utilizing the cloud for control have been researched. In the manufacturing industry, it is possible to reduce the workload for operation management by realizing control over on-site equipment through a virtual PLC on the cloud. PLC is an abbreviation for Programmable Logic Controller.

When realizing the control of on-site equipment utilizing a cloud, it is necessary to consider safety control. The concept of safety control involves protecting field workers and control related to prevention of accidents. As safety control, to hold a property of realizing a fail-safe, for instance, is required.

In such safety control, it is important to guarantee the response time. Especially, the largest value of the requested response time for transition from a state in which the on-site equipment is potentially harmful for workers to a safe state is clearly set based on the safety distance, etc., secured by the on-site equipment. In a case of control utilizing the cloud, there is a problem that the requested response time cannot be satisfied since transmission delay during communication over the public network between the site and the cloud is longer than transmission delay during control that is completed within the site.

In Patent Literature 1, a method is described in which some processing is performed inside the site instead to satisfy the requested response time. The system configuration in the method of Patent Literature 1 involves multiple networks, each of which is connected to a higher-level control device via a gateway device. In this configuration, if the result of control based on input by an input and output device inside the network is outputted to another input and output device within the same network, the gateway device performs the control on behalf of the higher-level control device.

In Patent Literature 1, in order to compensate for the disadvantage that a gateway device is also required at the site in addition to the upper-level control device, efforts are made to reduce the processing required by the gateway device, and to keep the number of the required gateway devices to a minimum. Specifically, only fragments of the processing on which response time constraints for safety are imposed in the control program are implemented in the gateway device. Then, as a whole system combining the control device and the gateway device, a distributed processing system in a vertical direction is configured to meet the safety requirements.

The control program of a control method referred to as sequence control (order control) in FA typically has a control structure where the operation for the same input varies depending on the context of the control. FA is an abbreviation for Factory Automation. Therefore, control that does not fit the context may be performed only by simply cutting out part of the control program, and the safety requirements are not satisfied. Thus, in Patent Literature 1, by specifying the control state in the control device with data relayed, the gateway device is made to ensure that control is conducted properly.

### CITATION LIST

### Patent Literature

Patent Literature 1: WO2022-239116 A

### SUMMARY OF INVENTION

### Technical Problem

In the method of Patent Literature 1, there is a time lag until the control state of the gateway device synchronizes with the control state of the control device. Due to this time lag, the gateway device may fail to perform all the controls that it should perform instead. As a result, a situation where the requested response time cannot be satisfied may occur.

The present disclosure is aimed at making it possible to satisfy the requested response time regarding safety control.

### Solution to Problem

A gateway device according to the present disclosure to relay communication between an input device, an output device, and a control device to control the output device based on an input signal from the input device includes:

an input decision unit to decide, when a non-safety output being an output signal to control a control state of the output device to be in a non-safe state is received from the control device, whether a safety input being an input signal to control the control state to be in a safe state has been received from the input device during a storage period before receiving, and an activation control unit to transmit a safety output being an output signal to control the control state of the output device to be in the safe state to the output device without relaying the non-safety output to the output device when it is decided that the safety input has been received by the input decision unit.

### Advantageous Effects of Invention

In the present disclosure, when the gateway device receives a non-safety output from the control device in a case in which the gateway device has received a safety input from the input device during a storage period before reception, the gateway device transmits a safety output to the output device without relaying the non-safety output to the output device. This ensures that even if there is a time lag until the control state of the gateway device synchronizes with that of the control device, it is possible to satisfy the requested response time regarding safety control.

### BRIEF DESCRIPTION OF DRAWINGS

FIG. 1 is an explanatory diagram of a normal system in the conventional art;

FIG. 2 is an explanatory diagram of an abnormal system in the conventional art;

FIG. 3 is a configuration diagram of a control system 100 according to First Embodiment;

FIG. 4 is a diagram of the hardware configuration of a gateway device 10 according to First Embodiment;

FIG. 5 is a diagram of the functional configuration of the gateway device 10 according to First Embodiment;

FIG. 6 is a flowchart of processing in the gateway device 10 according to First Embodiment;

FIG. 7 is an explanatory diagram of data relay processing according to First Embodiment;

FIG. 8 is an explanatory diagram of a state monitoring unit 114 according to First Embodiment;

FIG. 9 is an explanatory diagram of input decision processing according to First Embodiment;

FIG. 10 is an explanatory diagram of effects by the gateway device 10 according to First Embodiment;

FIG. 11 is a diagram of the hardware configuration of an engineering tool 40 according to Second Embodiment;

FIG. 12 is a diagram of the functional configuration of the engineering tool 40 according to Second Embodiment;

FIG. 13 is an explanatory diagram of basic state transition of the gateway device 10 related to Second Embodiment;

FIG. 14 is a diagram illustrating an example of state transition of the control device 30 according to Second Embodiment;

FIG. 15 is a diagram indicating an example of the state transition of the control device 30 according to Second Embodiment in a table format; and

FIG. 16 is a diagram indicating an example of the state transition of the gateway device 10 according to Second Embodiment in a table format.

### DESCRIPTION OF EMBODIMENTS

### First Embodiment

Description will be made on the premise of the following explanation.

In First Embodiment, the control device controls an input and output device using control logic. The input and output device operates the equipment to be controlled in accordance with the control by the control device. The control logic is composed by combining safety logics defined by standard specifications such as PLCopen, for example, and the control logic has a safe state and a non-safe state.

The non-safe state is a state in which the equipment to be controlled may harm people. The non-safe state is, for example, a state in which the equipment is in operation. The safe state is a state that is not the non-safe state. The safe state is, for example, a state in which the equipment is in suspension. In addition, according to the principle that the equipment is started as soon as safety is confirmed, the initial state is the safe state.

Based on an input signal from the input and output device and the current state, the control logic outputs an output signal in accordance with the state to be transitioned into in accordance with a state transition table. An input signal that performs transition from the safe state to the non-safe state is called a non-safety input. An input signal that performs transition from the non-safe state to the safe state is called a safety input. An output signal that is outputted when the state of the control logic is the safe state is called a safety output. An output signal that is outputted when the state of the control logic is the non-safe state is called a non-safety output.

### ***Description of Situation***

The operation of the safe suspension according to the method in Patent Literature 1 will be described by categorizing the operation to a normal system where the gateway device can perform control instead as expected, and an abnormal system where an issue arises.

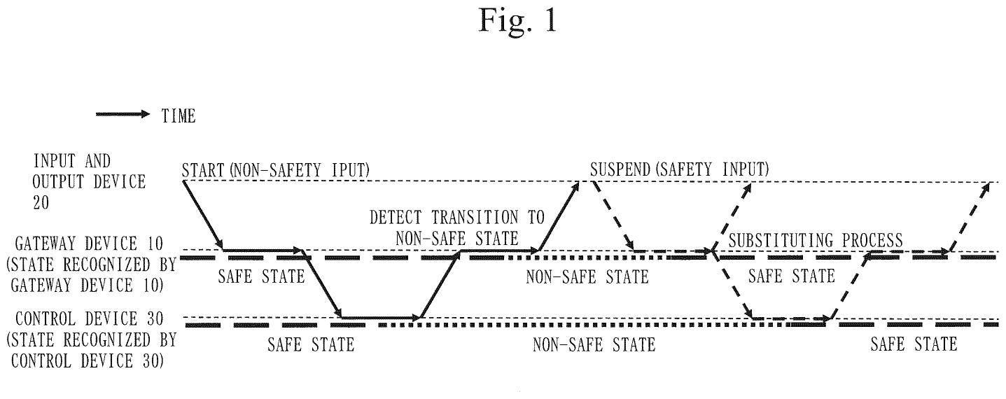

The normal system will be described with reference to FIG. 1. FIG. 1 is a timing chart with the horizontal axis being the time axis, expressing the flow of relaying inputs and outputs, and the propagation of state transitions between each device.

The initial state is the safe state. At this point, a non-safety input is transmitted from the input and output device. The gateway device receives the non-safety input. Then, the gateway device relays the non-safety input to the control device. When the control device receives the non-safety input, it switches the control state from the safe state to the non-safe state. Then, the control device transmits a non-safety output to the gateway device. When the gateway device receives the non-safety output, it switches the control state from the safe state to the non-safe state. Then, the gateway device relays the non-safety output to the input and output device. The input and output device receives the non-safety output. As a result, the control state becomes the non-safe state, and for example, the equipment starts to operate.

Subsequently, a safety input is transmitted from the input and output device. The gateway device receives the safety input. Then, the gateway device switches the control state from the non-safe state to the safe state. Further, the gateway device relays the safety input to the control device, and transmits a safety output to the input and output device on behalf of the control device. The input and output device receives the safety output. As a result, the control state becomes the safe state, and, for example, the equipment suspends the operation.

When the control device receives the safety input, it switches the control state from the non-safe state to the safe state. Furthermore, the control device transmits a safety output to the gateway device. When the gateway device receives the safety output, it relays the safety output to the input and output device. The input and output device receives the safety output; however, the control state has already been the safe state. Therefore, the state of the equipment being suspended continues, for example.

As described above, when the gateway device receives a safety input in the non-safe state, it transmits a safety output to the input and output device on behalf of the control device. That is, when the safety input is transmitted, the safety output is immediately given from the gateway device. In this manner, the requested response time regarding safety control is satisfied.

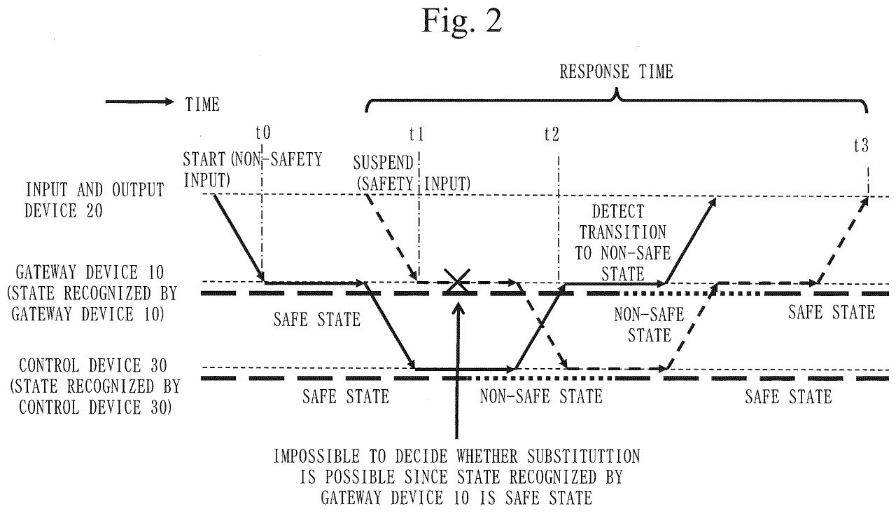

Description will be made on the abnormal system with reference to FIG. 2.

The initial state is the safe state. At this time, a non-safety input is transmitted from the input and output device. The gateway device receives the non-safety input. This clock time is referred to as time to. Then, the gateway device relays the non-safety input to the control device. When the control device receives the non-safety input, it switches the control state from the safe state to the non-safe state. Then, the control device transmits a non-safety output to the gateway device. The gateway device receives the non-safety output. This clock time is referred to as time t2. Then, the gateway device switches the control state from the safe state to the non-safe state. Then, the gateway device relays the non-safety output to the input and output device. The input and output device receives the non-safety output. In this manner, the control state becomes the non-safe state, and the equipment starts to operate, for instance.

Between the time to and the time t2, a safety input is transmitted from the input and output device. The gateway device receives the safety input. This clock time is referred to as time t1. Then, the gateway device relays the safety input to the control device. At the time t1, the control state in the gateway device is the safe state. Therefore, the gateway device does not transmit a safety output to the input and output device on behalf of the control device. This is because there is no need to suspend the equipment urgently if the control state is the safe state.

When the control device receives the safety input, it switches the control state from the non-safe state to the safe state. Then, the control device transmits a safety output to the gateway device. When the gateway device receives the safety output, it switches the control state from the non-safe state to the safe state. Then, the gateway device relays the safety output to the input and output device. The input and output device receives the safety output. As a result, the control state becomes the safe state, and the equipment suspends the operation, for instance. This clock time is referred to as time t3.

In the normal system, when the gateway device receives the safety input, the gateway device immediately transmits the safety output to the input and output device. However, in the abnormal system, although the gateway device receives the safety input at the time t1, the input and output device does not receive the safety output until the time t3. In other words, the response time regarding safety control becomes longer. Since it is necessary to guarantee the maximum value of the response time in any case, it becomes impossible to guarantee the system response time by the abnormal system.

In other words, it is necessary for the control state to be in the non-safe state in order for the gateway device to transmit the safety output to the input and output device on behalf of the control device. However, the gateway device does not recognize the control state being the non-safe state until the time t2 when it receives the non-safety output. Therefore, if the gateway device receives the safety input between the time to when it receives the non-safety input and the time t2 when it receives the non-safety output, the gateway device does not transmit the safety output to the input and output device on behalf of the control device. In other words, the gateway device fails to perform all the controls that it should perform instead.

This is because the transmission time from when the input and output device transmits the input signal until when the gateway device receives the output signal is longer than the transmission time from when the input and output device transmits the input signal until when the gateway device receives the input signal.

### ***Description of Configuration***

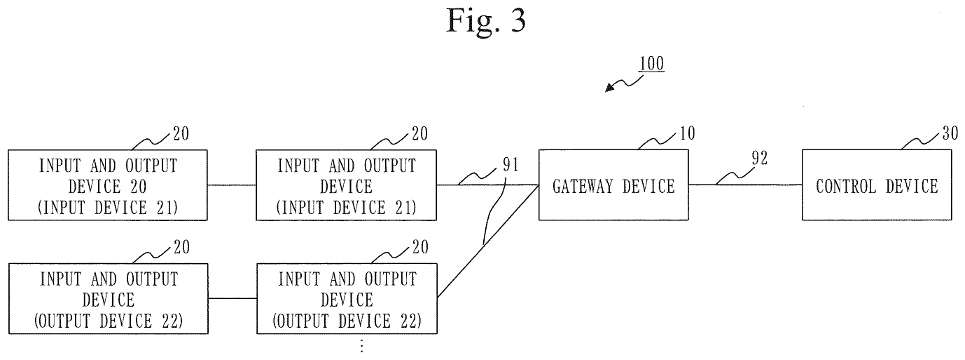

Description will be made on a configuration of the control system 100 according to First Embodiment with reference to FIG. 3.

The control system 100 is equipped with a gateway device 10, a plurality of input and output devices 20, and a control device 30. The gateway device 10 and each input and output device 20 are connected via a transmission path 91. The gateway device 10 and the control device 30 are connected via a transmission path 92. Here, the transmission path 91 is assumed to be a network such as LAN in a facility such as a factory. LAN is an abbreviation for Local Area Network. The transmission path 92 is assumed to be a public network.

The gateway device 10 relays communication between the input and output device 20 and the control device 30.

The input and output device 20 is divided into an input device 21 and an output device 22. The input device 21 is a device that transmits inputs from sensors or switches, etc. that are connected as input signals to upper-level devices. The output device 22 is a device that outputs actions in accordance with the output signals received from upper-level devices to actuators, etc. connected to the lower levels.

The control device 30 transmits output signals to the output device 22 and controls the output device 22 based on the input signals from the input device 21, and the control state. As a result, the actuator and the like connected to the output device 22 are operated.

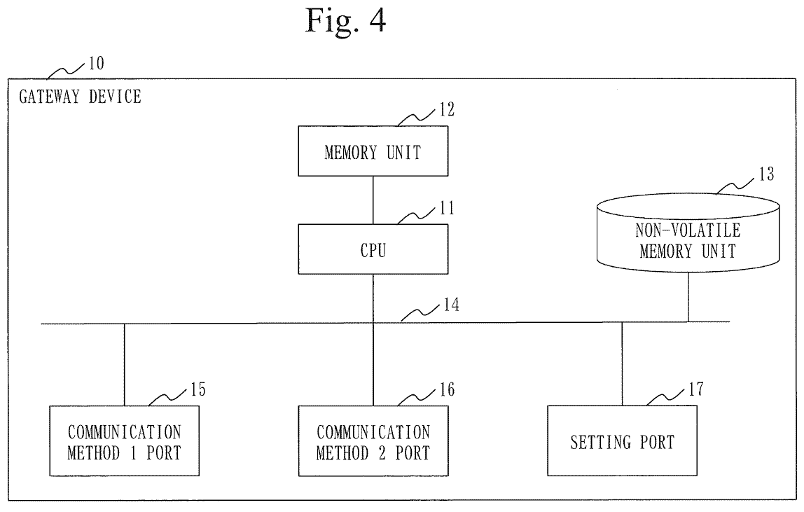

Description will be made on the hardware configuration of the gateway device 10 according to First Embodiment with reference to FIG. 4.

The gateway device 10 is a computer. The gateway device 10 is equipped with hardware components such as a CPU 11, a memory unit 12, a non-volatile memory unit 13, and a bus 14. CPU is an abbreviation for Central Processing Unit.

The non-volatile memory unit 13 stores the programs and parameters that realize the functions of the functional components provided in the gateway device 10. The CPU 11 loads the programs and parameters stored in the non-volatile memory unit 13 into the memory unit 12 via the bus 14. The CPU 11 executes the program loaded into the memory unit 12. In this manner, the functions of the gateway device 10 are realized.

These hardware components are developed in accordance with safety-related requirements. These hardware components may be duplicated, either in part or in entirety, in order to meet the necessary Safety Integrity Level (SIL). The term SIL is an abbreviation for Safety Integrity Level. It should be noted that the gateway device 10 may also be duplicated.

The gateway device 10 is equipped with a communication method 1 port 15 and a communication method 2 port 16 to communicate with other devices, and a setting port 17 to perform settings with engineering tools. In First Embodiment, the communication method 1 port is a port to communicate with the control device 30. In First Embodiment, the communication method 2 port is a port to communicate with the input and output device 20.

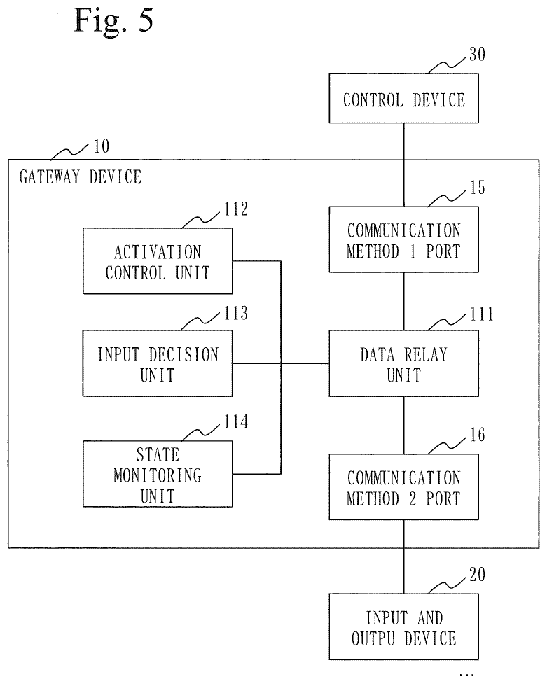

Description will be made on a functional configuration of the gateway device 10 according to First Embodiment with reference to FIG. 5.

The gateway device 10 is equipped with a data relay unit 111, an activation control unit 112, an input decision unit 113, and a state monitoring unit 114, as functional components.

The data relay unit 111 serves as a function to relay communication between the input and output device 20 and the control device 30. The input decision unit 113, the activation control unit 112, and the state monitoring unit 114 are functions to satisfy the requested response time regarding safety control.

### ***Description of Operation***

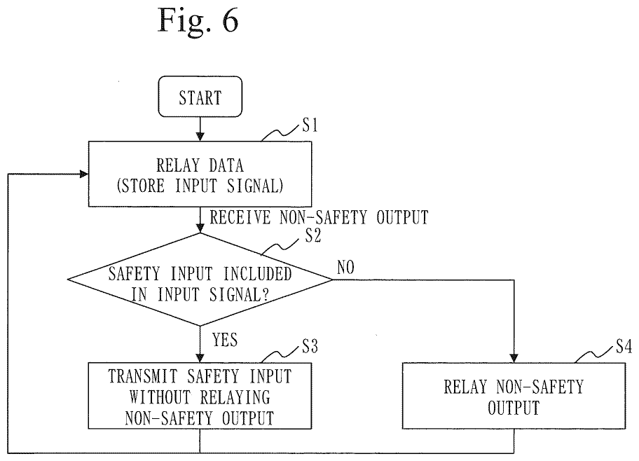

Description will be made on the operation of the gateway device 10 according to First Embodiment with reference to FIG. 6 through FIG. 9.

The operation procedure of the gateway device 10 according to First Embodiment corresponds to a relay method according to First Embodiment. Moreover, the program that realizes the operation of the gateway device 10 according to First Embodiment corresponds to a relay program according to First Embodiment.

Description will be made on the processing of the gateway device 10 according to First Embodiment with reference to FIG. 6.

### (Step S1: Data Relay Processing)

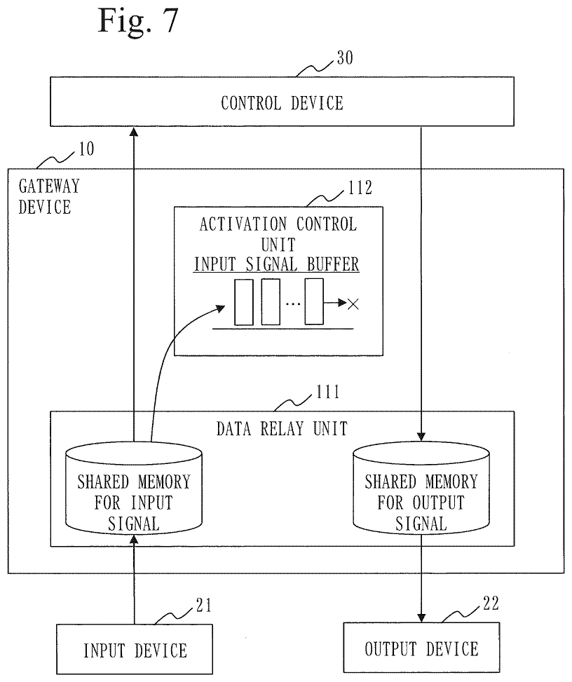

When the input and output device 20 is activated, the state transitions in accordance with input signals from the initial state, which is the safe state. At this time, as illustrated in FIG. 7, the data relay unit 111 relays the communication between the input and output device 20 and the control device 30 in the gateway device 10. In other words, the data relay unit 111 transmits the input signal received from the input device 21 to the control device 30 via shared memory for input signals, and transmits the output signal received from the control device 30 to the output device 22 via the shared memory for output signals.

At this time, as illustrated in FIG. 7, the activation control unit 112 stores the input signal received from the input and output device 20 in an input signal buffer. The input signal buffer is set in the memory unit 12, for example. Here, the period during which input signals are stored in the input signal buffer is called a storage period. The storage period is a period equal to or longer than the period from when the input signal is received from the input device 21 until when the output signal to control the output device 22 based on the input signal is received from the control device 30. The activation control unit 112 sequentially deletes the input signals that have passed the storage period from the input signal buffer.

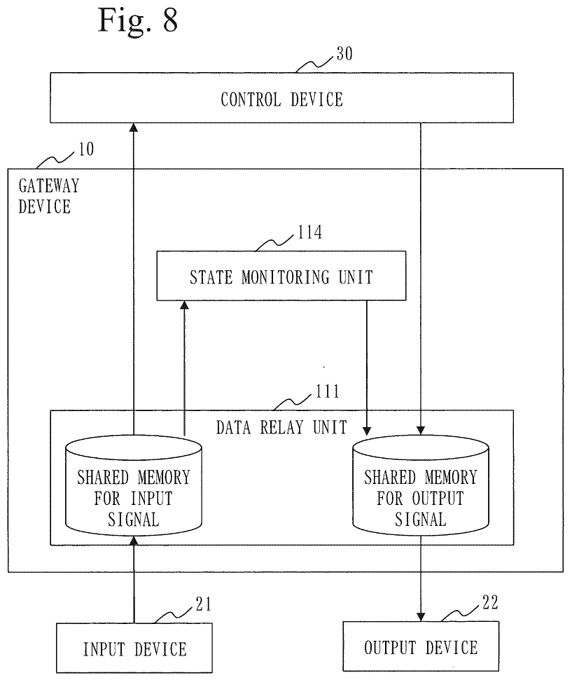

Note that the activation control unit 112 does not need to store the input signals during the time period when the input and output device 20 is in the non-safe state. Here, as illustrated in FIG. 8, the state monitoring unit 114 manages the state of the input and output device 20 by monitoring input signals. Therefore, the activation control unit 112 is supposed to not store input signals during the time period when the state of the input and output device 20 managed by the state monitoring unit 114 is the non-safe state.

Furthermore, the activation control unit 112 does not need to store the input signals that are not used by the input decision unit 113 to be described below among input signals.

During the execution of processing in Step S1, a non-safety input is transmitted from the input device 21. Then, the data relay unit 111 relays the non-safety input to the control device 30. The control device 30 executes the control logic and transmits a non-safety output to the gateway device 10. When the data relay unit 111 receives this non-safety output, the processing in Step S2 is performed.

### (Step S2: Input Decision Processing)

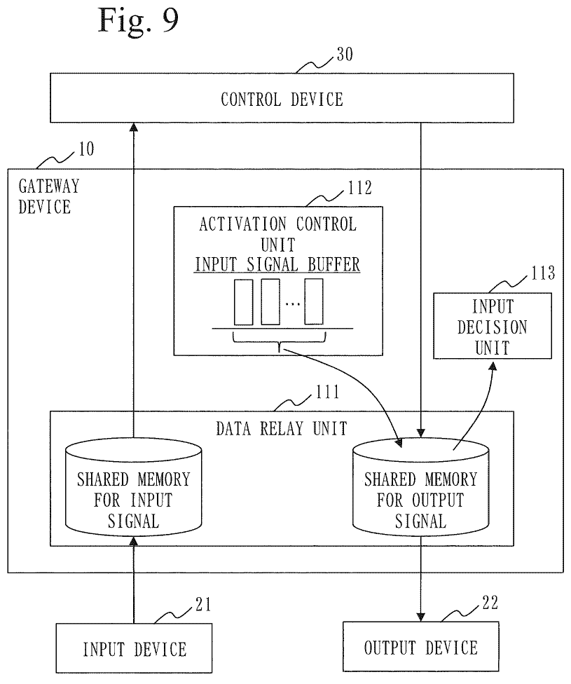

As illustrated in FIG. 9, the input decision unit 113 decides whether the input signal stored in the input signal buffer includes a safety input. That is, the input decision unit 113 decides whether it has received a safety input from the input device 21 during the storage period before receiving a non-safety output. In other words, the input decision unit 113 decides whether a safety input is transmitted from the input device 21 after a non-safety input is transmitted from the input device 21. This corresponds to the input decision unit 113 deciding whether the current state is a safe state when the input signals stored in the input signal buffer are applied in chronological order.

If a safety input is included, the input decision unit 113 proceeds to Step S3. On the other hand, if a safety input is not included, the input decision unit 113 proceeds to Step S4.

### (Step S3: Relay Hold Processing)

The activation control unit 112 does not relay the non-safety output to the output device 22, but transmits a safety output to the output device 22. In practice, the activation control unit 112 may instruct the data relay unit 111 to transmit the safety output without transmitting the safety output. In this manner, even if there is a safety input immediately after a non-safety input, the influence of the public network can be eliminated from the response time in the protective operation.

The activation control unit 112 stops relaying the non-safety output received from the control device 30 to the output device 22, and continues to transmit the safety output until it receives the safety output from the control device 30. When the activation control unit 112 receives the safety output from the control device 30, it returns the process to Step S1.

### (Step S4: Relay Continuation Process)

The activation control unit 112 transmits the non-safety output to the output device 22. In other words, the activation control unit 112 relays the non-safety output. However, in reality, the activation control unit 112 may instruct the data relay unit 111 to transmit the non-safety output without transmitting the non-safety output. Then, the activation control unit 112 returns the process to Step S1.

### Effects of First Embodiment

As stated above, when the gateway device 10 according to First Embodiment receives the non-safety output from the control device 30 in a case in which it has received a safety input from the input device 21 during the storage period before the reception, the gateway device 10 transmits the safety output to the output device 22 without relaying the non-safety output to the output device 22. As a result, even if there is a time lag until the control state of the gateway device 10 synchronizes with the control state of the control device 30, it is possible to satisfy the requested response time in safe control.

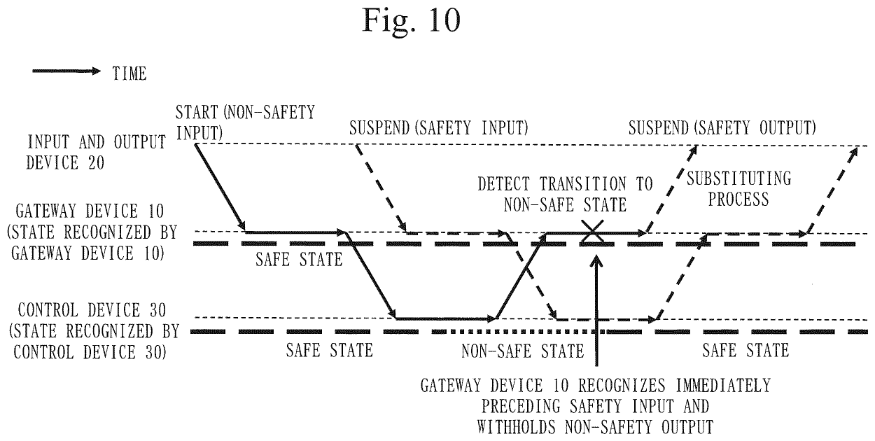

Description will be made on the effects of the gateway device 10 according to First Embodiment with reference to FIG. 10.

The initial state is the safe state. In this case, a non-safety input is transmitted from the input and output device 20. The gateway device 10 receives the non-safety input. Then, the gateway device 10 relays the non-safety input to the control device. Upon receiving the non-safety input, the control device 30 switches the control state from the safe state to the non-safe state. Then, the control device 30 transmits a non-safety output to the gateway device 10. The flow up to this point is similar to that in the abnormal system described with reference to FIG. 2.

A safety input is transmitted from the input and output device 20 before the gateway device 10 receives a safety output. The gateway device 10 receives the safety input. Then, the gateway device relays the safety input to the control device.

Thereafter, the gateway device 10 receives the non-safety output. Then, the gateway device 10 decides whether a safety input is included in the input signal stored in the input signal buffer (Step S2 in FIG. 6). In this case, the safety input is included. Therefore, the gateway device 10 does not relay the non-safety output to the output device 22, but transmits a safety output to the output device 22 (Step S3 in FIG. 6). Accordingly, the state of the input and output device 20 remains in the safe state, and the operation of the equipment is not started.

The response time is the time it takes from when a safety input is transmitted to when a safety output is transmitted. In other words, the response time is the time it takes from when the safety input is transmitted to when the safe state is realized. In the example of FIG. 10, the safe state is maintained as soon as the safety input is made. Therefore, the response time is substantially zero.

### ***Other Configurations***

### <First Variation>

In First Embodiment, each functional component is realized by software. However, as First Variation, each functional component may also be realized by a hardware component. With respect to First Variation, description will be made on different parts from First Embodiment.

When each functional component is realized by a hardware component, the gateway device 10 is equipped with electronic circuits instead of the CPU 11, the memory unit 12, and the non-volatile memory unit 13. The electronic circuit is a dedicated circuit that realizes the functions of each functional component, the memory unit 12, and the non-volatile memory unit 13.

As the electronic circuit, a single circuit, a composite circuit, a programmed processor, a parallel programmed processor, a logic IC, a GA, an ASIC, or an FPGA is assumed. GA is an abbreviation for Gate Array. ASIC is an abbreviation for Application Specific Integrated Circuit. FPGA is an abbreviation for Field-Programmable Gate Array.

Each functional component may be realized by a single electronic circuit, or may be distributed across multiple electronic circuits for realization.

### <Second Variation>

As Second Variation, a part of each functional component may be realized by hardware components, and the other part of each functional component may be realized by software.

The CPU 11, the memory unit 12, the non-volatile memory unit 13 and the electronic circuits are referred to as processing circuitry. In other words, the functions of each functional component are realized by the processing circuitry.

### Second Embodiment

In Second Embodiment, description will be made on a generation method of the control logic of the gateway device 10.

It is necessary for the gateway device 10 to realize control logic different from that of the control device 30 in order to realize the process illustrated in FIG. 6. The control logic realized by the gateway device 10 is generated by the control program executed in the control device 30. The control logic realized by the gateway device 10 can be achieved through state transitions.

It is necessary to derive the control logic realized by the gateway device 10 before the gateway device 10 starts control. As the control logic realized by the gateway device 10, a way to add an automatic derivation function to the engineering tool 40, a way to add the function to call and use the control logic derived beforehand by the gateway device 10 or a vendor of the engineering tool 40 to the gateway device 10, or the like can be considered.

In Second Embodiment, description will be made on an example in which the engineering tool 40 generates the control logic realized by the gateway device 10.

### ***Description of Configuration***

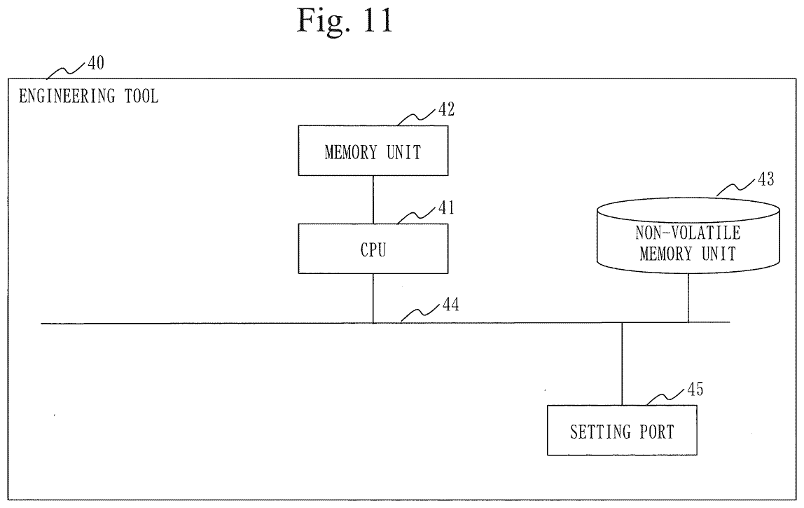

Description will be made on the hardware configuration of the engineering tool 40 according to Second Embodiment with reference to FIG. 11.

The engineering tool 40 is a computer. The engineering tool 40 is equipped with hardware components such as a CPU 41, a memory unit 42, a non-volatile memory unit 43, and a bus 44.

The non-volatile memory unit 43 stores the programs and parameters that realize the functions of the functional components provided in the engineering tool 40. The CPU 41 loads the programs and parameters stored in the non-volatile memory unit 43 into the memory unit 42 via the bus 44. The CPU 41 executes the program loaded into the memory unit 42. In this manner, the functions of the engineering tool 40 are realized.

The engineering tool 40 is equipped with a setting port 45 to perform settings of the gateway device 10 or the control device 30.

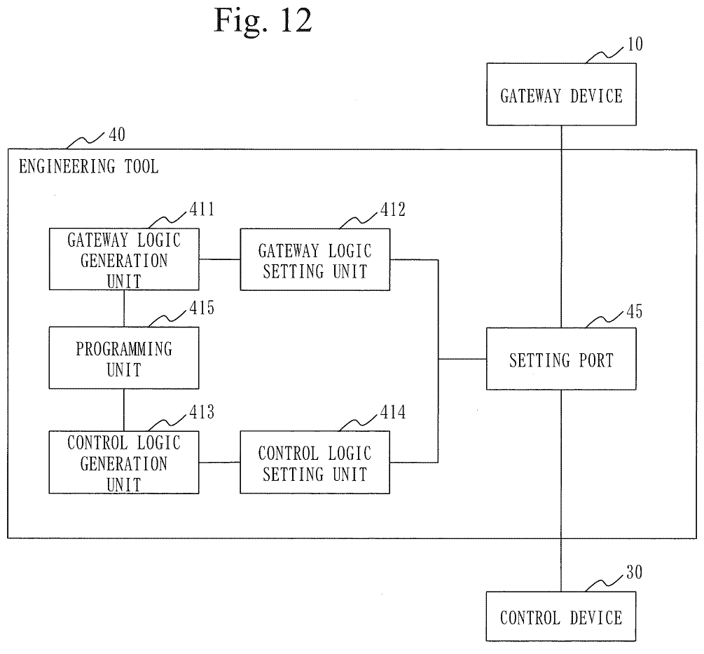

Description will be made on the functional configuration of the engineering tool 40 according to Second Embodiment with reference to FIG. 12.

The engineering tool 40 is equipped with a gateway logic generation unit 411, a gateway logic setting unit 412, a control logic generation unit 413, a control logic setting unit 414, and a programming unit 415, as functional components.

The gateway logic generation unit 411 is a function to generate the control logic of the gateway device 10. The gateway logic setting unit 412 is a function to set the control logic to the gateway device 10. The control logic generation unit 413 is a function to generate the control logic of the control device 30. The control logic setting unit 414 is a function to set the control logic to the control device 30. The programming unit 415 is a function to assist generation of the control logic.

Hereinafter, description will be made on the gateway logic generation unit 411 and the gateway logic setting unit 412.

### ***Description of Operation***

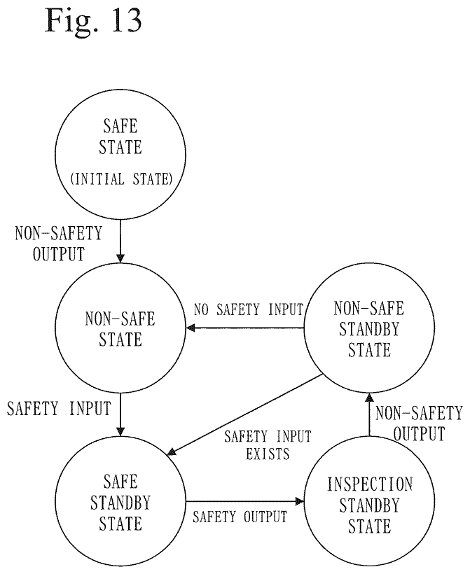

Description will be made on the operation of the engineering tool 40 according to First Embodiment with reference to FIG. 13 through FIG. 16.

The operation procedure of the engineering tool 40 according to Second Embodiment corresponds to a logic generation method according to Second Embodiment. Further, the program that realizes the operation of the engineering tool 40 according to Second Embodiment corresponds to a logic generation program according to Second Embodiment.

Description will be made on a basic state transition of the gateway device 10 according to Second Embodiment with reference to FIG. 13.

As the states, the gateway device 10 has a safe state, a non-safe state, a safe standby state, an inspection standby state, and a non-safe standby state.

Upon receiving a non-safety output in the safe state, the state transitions to the non-safe state. When a safety input is received in the non-safe state, the state transitions to the safe standby state. Upon receiving a safety output in the safe standby state, the state transitions to the inspection standby state. When a non-safety output is received in the inspection standby state, the state transitions to the non-safe standby state. If there is a safety input in the input signal buffer, which will be described later, in the non-safe standby state, the state transitions to the safe standby state. If there is no safety input in the input signal buffer, which will be described later, in the non-safe standby state, the state transitions to the non-safe state.

The safe standby state is a state where the non-safety output is not relayed to the output device 22, but the safety output is transmitted to the output device 22. In other words, the safe standby state is the state where the process of Step S3 in FIG. 6 is being performed.

The inspection standby state is a state where the non-safety output is being monitored while the input signal is stored in the input signal buffer. In other words, the inspection standby state is the state where the input signal is stored in the input signal buffer in Step S1 in FIG. 6.

The non-safe standby state is a state where it is decided whether to relay the non-safety output to the output device 22. In other words, the non-safe standby state is the state where the process of Step S2 in FIG. 6 is being performed.

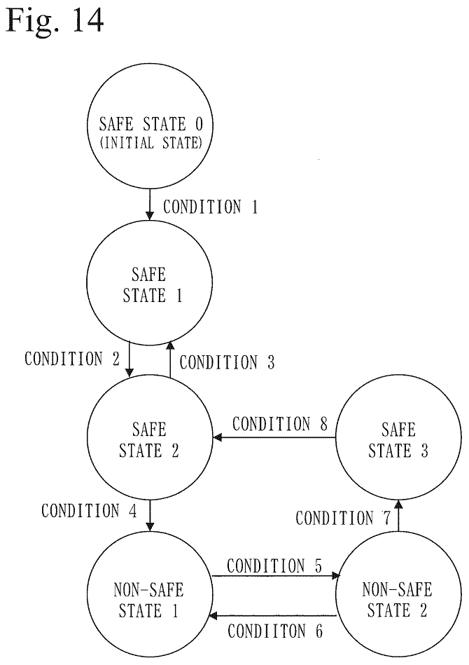

Description will be made on a concrete example of the state transitions of the gateway device 10 according to First Embodiment with reference to FIG. 14 through FIG. 16.

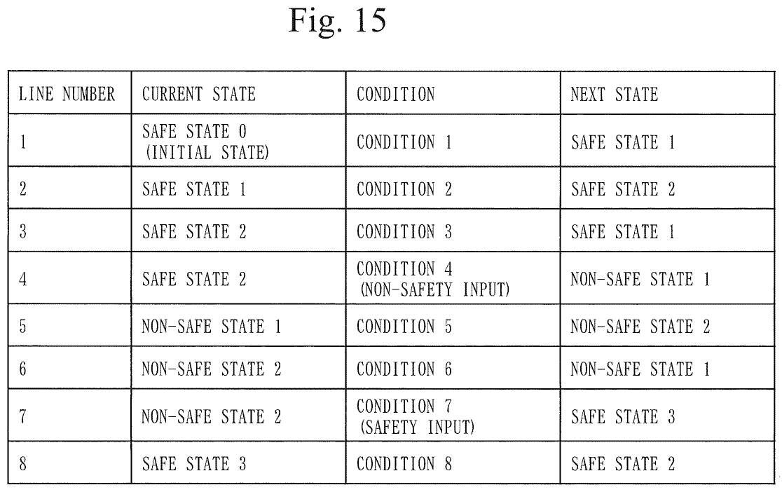

Here, the control logic of the control device 30 is assumed to be realized by the state transitions illustrated in FIG. 14. In FIG. 15, the state transitions illustrated in FIG. 14 are expressed in the table format.

In the state transitions illustrated in FIG. 14, if Condition 1 is met in a safe state 0 being the initial state, the state transitions to a safe state 1. If Condition 2 is met in the safe state 1, the state transitions to a safe state 2. If Condition 3 is met in the safe state 2, the state transitions to the safe state 1. If Condition 4 is met in the safe state 2, the state transitions to a non-safe state 1. In other words, to meet Condition 4 means a non-safety input. If Condition 5 is met in the non-safe state 1, the state transitions to a non-safe state 2. If Condition 6 is met in the non-safe state 2, the state transitions to the non-safe state 1. If Condition 7 is met in the non-safe state 2, the state transitions to a safe state 3. In other words, to meet Condition 7 means a safety input. If Condition 8 is met in the safe state 3, the state transitions to the safe state 2.

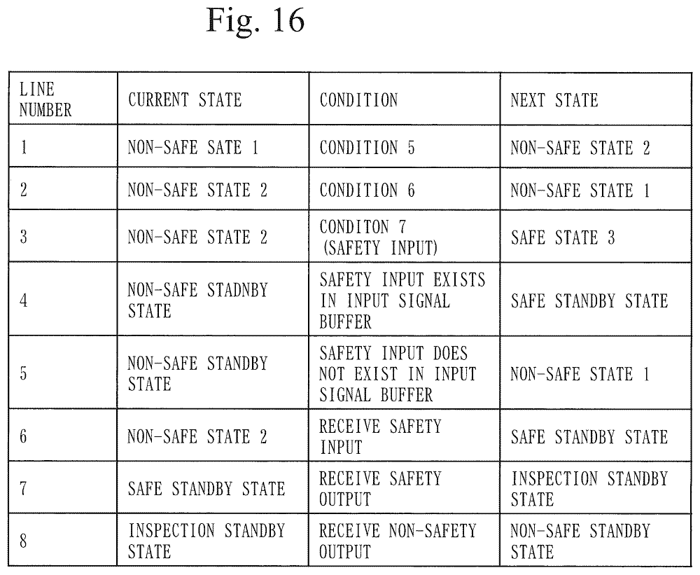

The gateway logic generation unit 411 sequentially performs (1) through (5) as follows, generating the state transitions illustrated in FIG. 16.
(1) The gateway logic generation unit 411 extracts records with the current state being the non-safe state from the table representing the control logic of the control device 30 (refer to FIG. 15). Here, three records of the line numbers 5 through 7 in FIG. 15 are extracted and set as the records of the line numbers 1 through 3 in FIG. 16.
(2) The gateway logic generation unit 411 adds a record with the current state being the non-safe standby state, the condition being the presence of the safety input in the input signal buffer, and the next state being the safe standby state. Here, the record of the line number 4 in FIG. 16 is added.

Additionally, the gateway logic generation unit 411 adds a line with the current state being the non-safe standby state, the condition being the absence of the safety input in the input signal buffer, and the next state being the non-safe state. When there are multiple lines in which the safe state transitions to the non-safe state, the gateway logic generation unit 411 adds records as many as the number of such lines. Here, the record of the line number 5 in FIG. 16 is added.
(3) The gateway logic generation unit 411 adds a record with the current state being the non-safe state, the condition being the reception of the safety input, and the next state being the safe standby state. Additionally, when there are multiple lines in which the safe state transitions to the non-safe state, the gateway logic generation unit 411 adds records as many as the number of such lines. Here, the record of the line number 6 in FIG. 16 is added.
(4) The gateway logic generation unit 411 adds a record with the current state being the safe standby state, the condition being the reception of the safety output, and the next state being the inspection standby state. Here, the record of the line number 7 in FIG. 16 is added.
(5) The gateway logic generation unit 411 adds a record with the current state being the inspection standby state, the condition being the reception of the non-safety output, and the next state being the non-safe standby state. Here, the record of the line number 8 in FIG. 16 is added.

Then, the gateway logic setting unit 412 sets the control logic indicated by the state transitions generated to the gateway device 10.

### Effects of Second Embodiment

As described above, the engineering tool 40 according to Second Embodiment generates the control logic of the gateway device 10 from the control logic of the control device 30. This makes it possible to easily generate the control logic of the gateway device 10.

Further, “unit” in the description above may be replaced with “circuit”, “step”, “procedure” “process” or “processing circuit”.

In the above, the embodiments and variations of the present disclosure have been described. Some of these embodiments and variations may be implemented in combination. Moreover, a part or some of the embodiments and variations may also be partially implemented. Note that the present disclosure is not limited to the embodiments and variations described above, and various modifications can be made as necessary.

### REFERENCE SIGNS LIST

100: control system; 10: gateway device; 11: CPU; 12: memory unit; 13: non-volatile memory unit; 14: bus; 15: communication method 1 port; 16: communication method 2 port; 17: setting port; 111: data relay unit; 112: activation control unit; 113: input decision unit; 114: state monitoring unit; 20: input and output device; 21: input device; 22: output device; 30: control device; 40: engineering tool; 41: CPU; 42: memory unit; 43: non-volatile memory unit; 44: bus; 45: setting port; 411: gateway logic generation unit; 412: gateway logic setting unit; 413: control logic generation unit; 414: control logic setting unit; 415: programming unit; 91: transmission path; 92: transmission path.

1. A gateway device to relay communication between an input device, an output device, and a control device to control the output device based on an input signal from the input device, the gateway device comprising:
processing circuitry
to decide, when a non-safety output being an output signal to control a control state of the output device to be in a non-safe state is received from the control device, whether a safety input being an input signal to control the control state to be in a safe state has been received from the input device during a storage period before receiving, and
to transmit a safety output being an output signal to control the control state of the output device to be in the safe state to the output device without relaying the non-safety output to the output device when it is decided that the safety input has been received.

2. The gateway device as defined in claim 1, wherein when it is decided that the safety input has not been received, the processing circuitry transmits a non-safety output being an output signal to control the control state to be in the non-safe state to the output device.

3. The gateway device as defined in claim 1, wherein when it is decided that the safety input has been received, the processing circuitry suspends relaying the non-safety output received from the control device to the output device until the safety output is received from the control device.

4. The gateway device as defined in claim 2, wherein when it is decided that the safety input has been received, the processing circuitry suspends relaying the non-safety output received from the control device to the output device until the safety output is received from the control device.

5. The gateway device as defined in claim 3, wherein when the safety output is received from the control device, the processing circuitry starts relaying the non-safety output received from the control device to the output device.

6. The gateway device as defined in claim 4, wherein when the safety output is received from the control device, the processing circuitry starts relaying the non-safety output received from the control device to the output device.

7. The gateway device as defined in claim 1, wherein the storage period is a period of time equal to or longer than a period of time from when a certain input signal is received from the input device, to when an output signal to control the output device based on the certain input signal is received from the control device.

8. The gateway device as defined in claim 2, wherein the storage period is a period of time equal to or longer than a period of time from when a certain input signal is received from the input device, to when an output signal to control the output device based on the certain input signal is received from the control device.

9. The gateway device as defined in claim 3, wherein the storage period is a period of time equal to or longer than a period of time from when a certain input signal is received from the input device, to when an output signal to control the output device based on the certain input signal is received from the control device.

10. The gateway device as defined in claim 4, wherein the storage period is a period of time equal to or longer than a period of time from when a certain input signal is received from the input device, to when an output signal to control the output device based on the certain input signal is received from the control device.

11. The gateway device as defined in claim 5, wherein the storage period is a period of time equal to or longer than a period of time from when a certain input signal is received from the input device, to when an output signal to control the output device based on the certain input signal is received from the control device.

12. The gateway device as defined in claim 6, wherein the storage period is a period of time equal to or longer than a period of time from when a certain input signal is received from the input device, to when an output signal to control the output device based on the certain input signal is received from the control device.

13. A relay method to relay communication between an input device, an output device, and a control device to control the output device based on an input signal from the input device, the relay method comprising
by a gateway device, deciding, when a non-safety output being an output signal to control a control state of the output device to be in a non-safe state is received from the control device, whether a safety input being an input signal to control the control state to be in a safe state has been received from the input device during a storage period before receiving, and
by the gateway device, transmitting a safety output being an output signal to control the control state of the output device to be in the safe state to the output device without relaying the non-safety output to the output device when it is decided that the safety input has been received.

14. A non-transitory computer readable medium storing a relay program to relay communication between an input device, an output device, and a control device to control the output device based on an input signal from the input device, the relay program causing a computer to function as a gateway device performing:
an input decision process to decide, when a non-safety output being an output signal to control a control state of the output device to be in a non-safe state is received from the control device, whether a safety input being an input signal to control the control state to be in a safe state has been received from the input device during a storage period before receiving, and
an activation control process to transmit a safety output being an output signal to control the control state of the output device to be in the safe state to the output device without relaying the non-safety output to the output device when it is decided by the input decision process that the safety input has been received.
